(19) United States
(12) Patent Application Publication
(10) Pub. No.: US 2021/0030179 A1
(43) Pub. Date: Feb. 4, 2021

(54) PRINTED PAPER STRAWS, ITS METHOD OF MANUFACTURING, AND PACKAGE OF UNIQUELY IDENTIFIABLE STRAWS

(71) Applicants: Stephanie Hensley, New York, NY (US); Alfredo Munoz, Jersey City, NJ (US)

(72) Inventors: Stephanie Hensley, New York, NY (US); Alfredo Munoz, Jersey City, NJ (US)

(21) Appl. No.: 16/568,194

(22) Filed: Sep. 11, 2019

Related U.S. Application Data
(63) Continuation-in-part of application No. 29/700,029, filed on Jul. 30, 2019.

(51) Int. Cl. A47G 21/18; B31D 5/00; C09D 11/03

(52) U.S. Cl. CPC A47G 21/186; A47G 2400/10; C09D 11/03; B31D 5/0095

(57) ABSTRACT

The present invention generally relates to a printed paper straw, process of manufacturing, and method of use. The present invention also relates to a package of straws that are uniquely identifiable by an easy-to-read text or drawings located on the external surface of each straw.

This application is a continuation-in-part of U.S. patent application Ser. No. 29/700,029 filed on Jul. 30, 2019.

### FIELD OF THE INVENTION

This disclosure relates to a printed paper straw, the process of manufacturing said printed paper straw and the method for using the paper straw for advertising and/or marketing. This disclosure additionally relates to a package of uniquely and identifiable straws, that are different from each other, and the method for packaging, and selling such package that improves upon the state of the art.

### BACKGROUND OF THE INVENTION

Plastic waste and the exorbitant amount of plastics being used in society today have created a plastic pollution problem. The abundance of plastic waste building up on the planet adversely affects human life, wildlife, wildlife habitats, and human health, among other things. Furthermore, animals are subject to great harm from plastics, both directly and indirectly through environmental experiences.

Plastic straws amount to a big portion of the plastic pollution problem. Plastic straws have consistently been on the top 10 list of items found on a beach. An estimated 500 million plastic straws are disposed of each day in the United States. These straws are used for seconds and are not recyclable.

For this reason and many others, including public pressure from patrons, customers, and others, governments and corporations are considering eliminating or phasing out single-use plastic straws. New and sustainable business models are being adopted by corporations such as Starbucks®, which has adopted a plan to phase out plastic straws.

The environmentalism could be understood as the “Zeitgeist” of our times and a huge global macro-trend. Companies and institutions are starting to pay careful attention to how the public perceives their approach to the environment as customers and voters are more and more demanding sustainable standards. Companies are spending millions of dollars in Public Relations campaigns to be perceived as environmentally responsible. Many companies provide straws for their customers, employees, and associates either as a commodity or as a tool for their visitors. In some cases, organization even provide gifts during certain events, such as conventions, corporate events, etc. More and more of these institutions are starting the understand that providing non-plastic straws is a very cost-effective PR strategy that also helps the planet.

There are currently many alternatives to plastic straws, such as PLA (polylactic acid), silicone, paper, hay, metal, bamboo, or even glass straws. Some of these environmentally-friendly alternatives as reusable straws, while other alternatives are single-use straws. While in some circumstances a reusable straw may be more friendly to the environment, there might be occasions where a single-use straw is required, due to hygiene, logistics, or even cost reasons.

Nowadays the most popular single-use alternative to plastic straws is paper straws. However modern paper straws offer some inconveniences in comparison to plastic straws. Paper straws are more expensive than plastic and they also have sogginess issues. Moreover, due to the current technology and process of manufacturing the paper straws, a text cannot be easily placed in the outer surface of the straw. Some solutions are currently working on solving the cost and sogginess disadvantages, but there is still no innovation on providing a cost-effective solution that permits to provide an easy-to-read text, logo or drawing in the outer surface of a paper straw.

There are many advantages for a text, quote, logo, drawing, symbol or figure to be placed in the outer surface of a straw. Firstly, companies can place their logos on the straw to advertise their brand. Secondly, texts could be used to inspire the reader/user of the straw. Thirdly, a drawing, symbol or figure can bring to the mind of the user a large meaning that a short text could not accomplish. However, for the text or logo to be really effective it may be necessary that it is shown only once in the product, and that is easily readable. From the communication point of view, having the logo or name many times in the same product might not be as effective as having it only once, as a single print stands out and bring more attention from the user to such text, logo or drawing. In addition, for a text to be easy to read, it should be straight, parallel to the longitudinal axis of the straw. In summary, when a text or logo is placed on a straw, it is usually preferred that such text is only shown once and that it is aligned with the longitudinal axis of the drinking straw. The power of advertising and communication through text, logos, and symbols on products is well-known and is already partially used in plastic straws.

However, due to the process of manufacturing paper straws, it is not possible to place a single logo or a long text in the outer surface of the straw in a longitudinal manner. While a long text across the longitudinal axis of the straw is currently available on plastic straws, it is not available in another type of single-use straws, such as in paper straws.

For a modern paper straw to be manufactured, it must be wrapped at an angle to resist structural changes. Paper straw is formed of individual paper strands, helicoidally wrapped in a structural arrangement so as to create a hollow interior along a length from a first end to a second end of the straw. Since the turn of the XXI century manufacturers of paper straws are using plies of paper wherein the utmost outer ply may have a small text, logos or drawings pre-printed on the paper strand prior to the manufacturing on the paper straw. As a pre-printed paper is used for the manufacturing of the paper straws and such pre-printed paper is placed at an angle during the manufacturing process in order to satisfy the structural integrity of the drinking straw. The width of the outer ply generates a helicoidal groove as result of the explained wrapping process.

Current paper straws prior art face the limitation that their appearance and is limited to what can be pre-printed on the thin outer paper strand that is used during the paper straw production. Due to the helicoidal nature of the final straw, if some logo or text is used, the same logo or text is repeated many times on the surface of the straw in a helicoidal manner. Additionally, it is never aligned in the longitudinal axis of the straw, making the print difficult to read and very ineffective from the communications, branding, and marketing point of view.

From a different perspective, due to the current packaging of straws, it is not possible to find personalize straws where each straw in the package is different from another. When a customer buys a package of straws, they are all the same, making it very difficult to have a unique differentiation among the straws. This current problem exists not only with paper straws but with any other type of straws, such as plastic, bamboo, metal, or glass.

Being able to differentiate one straw from each other offers great value not only from the hygienic point of view but also from the marketing angle. It is common in family gatherings or in parties that all the glasses, drinks and straws are the same, creating confusion on to whom each glass belongs. Some people may use different glasses to solve this problem but it is not a very useful method. It seems more useful to recognize each people's drink by having a unique differentiative straw for each user. Although a customer could always buy packages of straws with different colors, the fact that the straws in the same package are currently the same among themselves will make it very costly and inefficient to buy as many packages of straws as people will be in the event. There might not even be enough colors available in the market to have enough differentiation as needed in large groups.

Having a package of straws with different texts, quotes, or symbols on the straws inside the same package also offers a large advantage from the marketing aspect, especially for merchandising. Alternatively, if an organization provides packages of uniquely identifiable non-plastic straws, it will make a profit for each sale and also from the intangible value associated with PR and brand value of associating the organization with the plastic-free movement and environmentalism.

Therefore, there is a need in the art for printed paper straws that provide an easy-to-read text along the longitudinal axis of the straw, a single text, logo or drawings on the outer surface of the straw, a printed paper straw system that provides such result, a method of manufacturing such straw, a method for branding, and marketing and advertising on a printed paper straw. These and other features and advantages of the present invention will be explained and will become obvious to one skilled in the art through the summary of the invention that follows.

There is also a need in the art for packages of straws that include straws that are uniquely identifiable by having easy-to-read text along the straw, logo, or drawings to improve the use of the straws by the customers and for merchandisers. These and other features and advantages of the present invention will be explained and will become obvious to one skilled in the art through the summary of the invention that follows.

### SUMMARY OF THE INVENTION

Accordingly, it is an object of the present invention to provide printed paper straws that has a potential use of millions per day as they can send a direct advertisement in a text that reads in the same orientation as the longitudinal axis of the straw. Due to the previous state of the art, paper straw messages could only be printed at an angle, due to paper straw structure requirements. The processes disclosed herein, allow for vertical and/or horizontal advertising, messages, and expressions on the straw for the first time. This strength in marketing allows slogans, and business names to fit on straws for the first time due to various ratios and sizes that are regularly used as straws in the state of the art.

Accordingly, it is an object of the present invention to provide a printed paper straw system, process of manufacturing, and method of use that a paper straw, pad-printing, FDA approved ink to be in direct contact with food, and a text or an expression positioned on the exterior surface of the straw and in the same direction as the longitudinal axis of the straw. This combination is new and useful in the state of the art in providing an eloquent solution which is useful not only for the consumption of food, but in advertising, as well as in creating environmental impacts which are enhanced through the reduction of plastic straw waste as well as the enhancement of advertising methods and/or processes which have never been accomplished in the art.

Accordingly, it is an object of the present invention to provide a printed paper straw, a printed paper straw system, a process of manufacturing, and a method of use that provides an easy-to-read and efficient communication of messages on paper straws.

Accordingly, it is an additional object of the present invention to provide a package of straws that are uniquely identifiable by having text, drawings or symbols on each drinking straw, and the method to pack and sell a group of straws with different texts or drawings.

According to some embodiments of the present invention, a printed paper straw, comprising a paper tubular device comprising an outer ply with a consistent width, at least one additional inner ply, an exterior surface formed by the outer ply, two helicoidal groove lines on said exterior surface that are separated by a consistent distance, a longitudinal axis, a first end-point at the end of said longitudinal axis, a second end-point at the opposite end of said longitudinal axis, a hollow interior from said first end-point to said second-end point, and a text that has a length and that comprises one or more words, wherein the hollow interior is configured to move liquid from said first end-point to said second end-point, wherein the text is on the exterior surface of the paper tubular device, wherein the text reads in the same direction as the longitudinal axis of the paper tubular device, wherein the length of the text is longer than the distance between the two helicoidal groove lines, wherein the text is pad-printed after the paper tubular device is manufactured, and wherein the text is pad-printed with one or more colors of ink that is ingestible or food grade.

According to some embodiments of the present invention, a printed paper straw, comprising a paper straw, constructed of at least two plies of paper of a certain width, and that comprises a hollow, an exterior surface, a longitudinal axis, a helicoidal groove line at the exterior surface caused by the width of one of said plies of paper, and a text comprising one or more words and that has a length, wherein said text is on said exterior surface of the paper straw and reads in the same direction as said longitudinal axis of said paper straw, wherein the length of said text is longer than the width of one of the plies of paper that construct the paper straw, wherein the text is pad-printed after the paper straw is manufactured; and wherein the text is pad-printed with one or more colors of ink that is ingestible or food grade ink.

According to some embodiments of the present invention, a printed paper straw comprised of a paper tubular device that is pre-manufactured and that comprises at least three plies of paper, wherein the outer ply is undyed or have the same color across its consistent width.

According to some embodiments of the present invention, a printed paper straw wherein the paper straw is pre-manufactured and the plies of paper that construct the paper straw are undyed or have the same color.

According to some embodiments of the present invention, a printed paper straw wherein the paper straw is constructed of three plies of paper.

According to some embodiments of the present invention, a printed paper straw wherein the length of the text is at least two times longer than the distance between the two helicoidal groove lines, having as a result at least one helicoidal groove line crossing the text.

According to some embodiments of the present invention, a printed paper straw wherein the ingestible or food grade ink is approved by the Food & Drug Administration (FDA) or by the United States Department of Agriculture (USDA) to be in direct contact with food or liquids.

According to some embodiments of the present invention, a printed paper straw wherein each letter of the text is placed in the perpendicular direction of the longitudinal axis of said paper tubular device.

According to some embodiments of the present invention, a printed paper straw wherein each word of the text is placed in the perpendicular direction of the longitudinal axis of the straw.

According to some embodiments of the present invention, a printed paper straw wherein the paper tubular device is flexible, foldable, bendable or articulated with a hinge.

According to some embodiments of the present invention, a printed paper straw comprising a drawing or a logo, wherein the drawing or the logo is on the exterior surface of the paper tubular device, wherein the drawing or the logo is pad-printed, and wherein the drawing or the logo is pad-printed with one or more colors of ink that is ingestible or food grade.

According to some embodiments of the present invention, a printed paper straw comprising a paper tubular device comprising an outer ply with a consistent width, at least one additional inner ply, an exterior surface formed by the outer ply, two helicoidal groove lines on the exterior surface that are separated by a consistent distance, a longitudinal axis, a first end-point at the end of said longitudinal axis, a second end-point at the opposite end of the longitudinal axis, a hollow interior from the first end-point to said second-end point; and one single drawing or logo that has a length, wherein the hollow interior is configured to move liquid from the first end-point to the second end-point, wherein the single drawing or logo is on the exterior surface of the paper tubular device, wherein the one single drawing or logo is shown only once and is not repeated anywhere else on the printed paper straw, wherein the single drawing or logo is pad-printed after the paper tubular device is manufactured, and wherein the single drawing or logo is pad-printed with one or more colors of ink that is ingestible or food grade.

According to some embodiments of the present invention, a printed paper straw comprising a paper straw, constructed of at least two plies of paper of a certain width, and that comprises a hollow, an exterior surface, a longitudinal axis, a helicoidal groove line at the exterior surface caused by the width of one of said plies of paper, and one single drawing or logo that has a length, wherein the single drawing or logo is on the exterior surface of the paper straw, wherein the one single drawing or logo is shown only once and is not repeated anywhere else on the same paper straw, wherein the single drawing or logo is pad-printed after the paper straw is manufactured, and wherein the single drawing or logo is pad-printed with one or more colors of ink that is ingestible or food grade.

According to some embodiments of the present invention, a printed paper straw comprising a text or an expression, wherein the text or the expression comprises one or more words and that has a length, wherein the text or the expression is on the exterior surface of the paper tubular device and reads in the same direction as the longitudinal axis of the paper tubular device, wherein the length of the text or the expression is longer than the distance between the two helicoidal groove lines, wherein the text or the expression is pad-printed on the paper tubular device, and wherein the text or the expression is pad-printed with one or more colors of ink that is ingestible or food grade.

According to some embodiments of the present invention, a printed paper straw comprising a text, wherein the text comprises one or more words and that has a length, wherein the text or the expression is on the exterior surface of the paper straw and reads in the same direction as the longitudinal axis of the paper straw, wherein the length of the text or the expression is longer than the width of one of the plies of paper that construct the paper straw, and wherein the text or the expression is pad-printed with one or more colors of ink that is ingestible or food graded ink.

According to some embodiments of the present invention, a printed paper straw wherein the printed paper straw is manufactured as an integrated process comprising of a paper straw production apparatus comprising of two or more paper rolls, a soaker with adhesive, a plurality of controls, at least one aligner, a winding machine, a plurality of guides, at last one chopper, and a conveyor belt system, and a pad-printing apparatus comprising of a plate prepared to hold ingestible or food grade ink, a mechanical arm, an ink refresher, and a conveyor belt system.

According to some embodiments of the present invention, a printed paper straw wherein the printed paper straw is manufactured as an integrated process that further comprises an automated packaging apparatus that combines in a container a group of said printed paper straw.

According to some embodiments of the present invention, a printed paper straw wherein the printed paper straw is manufactured as an integrated process that further comprises a graphical user interface.

According to some embodiments of the present invention, a printed paper straw wherein the paper straw is flexible, foldable, bendable or articulated with a hinge.

According to some embodiments of the present invention, a package of printed paper straws comprising two or more uniquely differentiated printed paper straws, each constructed of a paper tubular device comprising an outer ply with a consistent width, at least one additional inner ply, an exterior surface formed by the outer ply, a print on the exterior surface, two helicoidal groove lines on the exterior surface that are separated by a consistent distance, and a longitudinal axis, and a cover or a box that holds said two or more uniquely differentiated printed paper straws, wherein the print on each of the two or more uniquely differentiated printed paper straws is what creates the unique differentiation among the two or more printed paper straws.

According to some embodiments of the present invention, a package of printed paper straws comprising three or more uniquely differentiated printed paper straws, each constructed of at least three plies of paper of a certain width, and that comprises a hollow, an exterior surface, a print on the exterior surface, a longitudinal axis, and a helicoidal groove line at the exterior surface, and a cover or a box that holds said three or more uniquely differentiated printed paper straws, wherein the print on each of the three or more uniquely differentiated printed paper straws is what creates the unique differentiation among the three or more printed paper straws.

According to some embodiments of the present invention, a package of printed paper straws wherein each of the two or more uniquely differentiated printed paper straws is repeated inside the package at least twice.

According to some embodiments of the present invention, a package of printed paper straws wherein each of the three or more uniquely differentiated printed paper straws is repeated inside the package at least twice.

According to some embodiments of the present invention, a package of printed paper straws wherein each and every printed paper straw contained inside said package is uniquely differentiated from each other.

According to some embodiments of the present invention, a package of printed paper straws wherein the print may be any print selected from a group of prints consisting of a text, an expression, a drawing, a logo, a symbol, an image, a slogan, a business name, and a removable sticker, and wherein said print is pad-printed with one or more colors of ink that is ingestible or food grade.

According to some embodiments of the present invention, a package of printed paper straws wherein the print on the exterior surface of said uniquely differentiated printed paper straws is a single print.

According to some embodiments of the present invention, a package of printed paper straws wherein the print is a text that that reads in the same direction as the longitudinal axis of said paper straw, and wherein the length of the text is longer than the width of one of the plies of paper that construct each of the two or more uniquely differentiated printed paper straws.

According to some embodiments of the present invention, a package of printed paper straws wherein the length of the text is at least two times longer than the distance between the two helicoidal groove lines, having as a result at least one helicoidal groove line crossing the text.

According to some embodiments of the present invention, a package of printed paper straws wherein the length of the text is longer than three times the width of one of the plies of paper, having as a result at least two helicoidal groove line crossing the text.

According to some embodiments of the present invention, a method for manufacturing printed paper straws, the system comprising providing at least two rolls of paper for straw production onto a paper feeder stand, pulling the paper rolls and strip at least one of them over an adhesive bath in a soaker, pulling the paper through guides into a winding machine that combines the two or more strips of paper from the rolls into a single, long, tubular paper device, cutting the single, long, tubular paper device into the desired length to obtain one or more paper straws, transporting said one or more paper straws to a pad-printing platform, setting up with a desired print a template that absorbs or attach ingestible or food graded ink, pressing a pad into said template, moving the pad to the one or more paper straws, pressing the pad into the one or more paper straws, removing the pad, conveying the one or more paper straws for packing or storage.

Accordingly, it is an object of the present invention to provide a printed paper straw system, process of manufacturing, and method of use that uses pad-printing with an FDA approved ink so anything can be printed on a paper straw, including a customized message, a text, a logo, advertising and/or other marketing slogan on a straw.

Accordingly, it is an object of the present invention to provide a printed paper straw system, process of manufacturing, and method of use that can accommodate long text messages such as slogans and/or sentences and/or paragraphs on a paper straw.

Accordingly, it is an object of the present invention to provide a printed paper straw system, process of manufacturing, and method of use that can print an expression on a paper straw that reads in the same direction of the longitudinal axis of the straw.

Accordingly, it is an object of the present invention to provide a printed paper straw system, the process of manufacturing, and method of use that can print expression on a straw that reads in any desire orientation on the straw.

Accordingly, it is an object of the present invention to provide a system, process of manufacturing, and method of use that prints a message on a longitudinal, hollow, tubular, biodegradable object.

Accordingly, it is an object of the present invention to provide a printed paper straw system, process of manufacturing, and method of use that provides a package of straws that includes straws made of metal, bamboo or glass wherein the package contains at least two different straws uniquely identified by a mark and wherein such mark is done on the exterior surface of the straw by a laser-etch.

Accordingly, it is an object of the present invention to provide a printed paper straw system, process of manufacturing, and method of use that provides a package of straws that includes printed paper straws wherein the package contains at least two different straws uniquely identified by a mark and wherein such mark is done by a print on the exterior surface of the straw created by pad-printing on the straw.

Accordingly, it is an object of the present invention to provide a printed paper straw system, process of manufacturing, and method of use that provides a package of straws that includes straws wherein the package contains at least three different straws uniquely identified by a mark and wherein such mark is done by a text on the exterior surface of the straw and wherein the text reads in the direction of the longitudinal axis of the straw.

### BRIEF DESCRIPTION OF THE DRAWINGS

FIG. 1. Is a perspective view of a printed straw, in accordance with an embodiment of the present invention;

FIG. 2a-2d. Is a perspective view of a printed paper straw wherein the prints are text, a single logo, drawings or a combination of them, in accordance with an embodiment of the present invention;

FIG. 3. Is a view of a package of straws that contains straws with different marks or prints to be able to differentiate the straws among themselves, in accordance with an embodiment of the present invention;

FIG. 4. Is a view of a package of straws, with the straws partially out of the package, wherein there are at least two different marks or prints on the straws, to be able to differentiate the straws among themselves, in accordance with an embodiment of the present invention;

FIG. 5a-5f. are illustrations of the current prior art related to paper straws that have prints on their surface;

FIG. 6a-6e. are perspectives, elevational and top and bottom views of a printed straw system, in accordance with an embodiment of the present invention;

FIG. 7. Is a diagrammatic description of the paper straw production, as part of the printed paper straw system, in accordance with an embodiment of the present invention;

FIG. 8a-8h. Is an illustration of the processing and method for the manufacturing of the paper straw, as part of the printed paper straw system, in accordance with an embodiment of the present invention;

FIG. 9a-9d. Is an illustration of the processing and method for the pad-printing, as part of the printed paper straw system, in accordance with an embodiment of the present invention;

FIG. 10. Is a process flow for an exemplary method for pad-printing the printed paper straw, in accordance with an embodiment of the present invention;

FIG. 11. Is a process flow for an exemplary method for manufacturing the printed paper straw, in accordance with an embodiment of the present invention;

FIG. 12a-12d. are perspective, elevational and top and bottom views of a straw with a quote, in accordance with an embodiment of the present invention;

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces, and figures presented. It should be understood, however, that the terms are used only for purposes of description, and are not intended to be used as limitations. Accordingly, orientation of an object or a combination of objects may change without departing from the scope of the disclosure.

Accordingly, it is an object of the present invention to provide a printed paper straw, a printed paper straw system, a process of manufacturing, and a method of use that provides an easy-to-read and efficient communication of messages on paper straws.

Accordingly, it is an additional object of the present invention to provide a package of straws that are uniquely identifiable by having text, drawings or symbols on each drinking straw, and the method to package and sell a package of straws with straws with different texts or drawings.

According to an embodiment of the present invention, a printed straw may be formed by a pre-manufactured drinking straw (02) made of paper, a print (03) on the exterior surface (22) of the drinking straw (02). The print might be a text (04) comprising one or more words, a logo (05) or a drawing (06) or symbol. The print (03) is done with ink (07) that has special characteristics to maintain the health standards for any product in direct contact with food or drinks. In some embodiments the pre-manufactured drinking straw may be made of any other material, such as PLA, metal, bamboo, hay, or glass. One of ordinary skill in the art would appreciate that the straw could be manufactured with a myriad of materials without departing from the spirit and scope of the invention.

According to an embodiment of the present invention, a package of drinking straws (08) may comprise uniquely identifiable straws (09) that may include distinctive text (04), comprising one or more words, logos (05) or drawings (06) on the exterior surface (22) of the straw, as a way to differentiate the straws among each other.

According to an embodiment of the present invention, a printed paper straw system (10) may comprise a paper straw and a cleaner or a straw cleaning brush that may consist of a hard handle and a nylon or coconut fiber brush that facilitate the cleaning of the inside of the straw. In some embodiments the handle may be metallic while in other embodiments the handle may be made of any other rigid material such as wood, bamboo or even plastic.

According to an embodiment of the present invention, a printed paper straw system (10) may include a Paper Straw Device (20), a paper straw production system (40), and a pad-printer apparatus (120). In alternative embodiments, the printed paper straw system (10) may additionally include other systems, components, and/or features, such as a graphical user interface (160).

According to an embodiment of the present invention, a printed paper straw system (10) may include a paper straw device (20) that may be a pre-manufactured drinking straw (02) made of paper that may be manufactured by any third party. In other embodiments, the paper straw device (20) may be exclusively manufactured as part of the printed paper straw system. In a preferred embodiment, the paper straw is formed of any suitable size, shape, length, width, circumference, and design, and is configured to move liquid from one location to another by depressurization and/or pressure removal from the interior of the straw. In a preferred embodiment the pre-manufactured drinking straw (02) may be undyed while in other embodiments the paper straw may be printed on the exterior surface. In an alternative embodiment, the paper straw may be rigid while in another embodiment the paper straw may be foldable, bendable or articulated with a hinge near the top for bending the straw into a more favorable angle for sipping.

According to an embodiment of the present invention, a printed paper straw system (10) may be formed by a longitudinal tubular paper device (12), having an exterior surface (22) which wraps cylindrically around a circumference that has an interior surface (26) on the opposite side of the exterior surface (22). Together these surfaces form a hollow interior (22) which extends the length of the straw from a first opening (30) at a first end (28) to a second opening (34) at a second end (32).

According to an embodiment of the present invention, a printed paper straw may be formed by a longitudinal paper drinking straw comprising a longitudinal axis and layers of paper placed in a helicoidal manner along the longitudinal axis creating a tubular structure with a hollow space inside. In a preferred embodiment, the paper straw is formed of individual paper strands, helicoidally wrapped in a structural arrangement to create a hollow interior along a length from a first end to a second end. In a preferred embodiment, the paper straw is constructed of three plies of paper that have some adhesive between each ply to provide more rigidity and reduce sogginess when the paper straw is inside the liquids. The paper straw may include an exterior surface (22), a hollow interior (24), an interior surface (26), a first end (28), a first opening (30), a second end (32), a second opening (34), and a helicoidal groove (38).

In some embodiments the helicoidal groove line is caused by the joint of said plies of paper, while in other embodiments two helicoidal groove lines are the result of the edges of the outer thin strip or ply of paper that has a consistent width and that created a helicoidal form while wrapping it. In some embodiments, a wax coating may be provided to the paper straw. In a preferred embodiment, the paper straw is formed from a paper material created by combining paper and adhesive and/or wax. In some embodiment, the adhesive may be certified to be in products that are in direct contact with food and drinks. In an alternative embodiment, other methods of combining the paper that does not rely on adhesive are used, such that the paper is strong enough for creating a paper straw structure are hereby contemplated for use, such as but not limited to, folding, binding, clipping, stamping, and/or other methods of forming a paper straw from multiple pieces of paper and/or paper strands and/or from a single sheet of paper.

According to an embodiment of the present invention, a printed paper straw may be formed by a longitudinal paper drinking straw, formed by spiraling one or more layers of a strip of paper around a cylindrical surface and gluing it at the ends. In this scenario, the drinking paper straw may be a continuous straw without any helicoidal grooves (38). In another scenario the strips of paper used as plies may be thin, creating a multitude of helicoidal grooves (38).

According to an embodiment of the present invention, a printed paper straw may be formed from paper that is biodegradable, renewable, biodegradable, recyclable, compostable and that break down if left out in nature within a short period of time. In a preferred embodiment. In a preferred embodiment a printed paper straw may be formed from paper made of wood pulp or Kraft paper. One of ordinary skill in the art would appreciate that the paper straw could be manufactured with a myriad of type of papers or combination of papers without departing from the spirit and scope of the invention.

According to an embodiment of the present invention, a printed paper straw may comprise a paper straw wherein the end-points of the straw are perpendicular to the sidewall of the straw, while in other embodiments the end-points might not be perpendicular, such as those used for Bubble-Tea or alike. According to an embodiment of the present invention, the diameter of the straw may be thin in comparison with the length of the straw, while in other cases the diameter might be substantially large. One of ordinary skill in the art would appreciate that the geometrical dimensions of paper straw could be many, without departing from the spirit and scope of the invention.

According to an embodiment of the present invention, a printed paper straw may comprise a paper straw wherein the plies or paper rolls have the same characteristics and color while in other embodiments the paper rolls might be different creating a zebra-skin-like effect on the outside of the wall of the straw. In a preferred embodiment the outer ply may fully cover the exterior surface having a pre-print of any kind, such as a zebra-skin-like print. In other embodiments, all the paper rolls used for the manufacturing of the paper straw might not have any pre-printing and might be plain. One of ordinary skill in the art would appreciate that the paper straw could be manufactured with a myriad of configurations of the paper rolls without departing from the spirit and scope of the invention.

According to an embodiment of the present invention, a printed paper straw may be configured as a longitudinal device for accepting pad-printing (16) of a print (03) or expression (36) with specific meaning, and/or other imagery (06), text (04), and any other graphical representation on the paper straw. In a preferred embodiment, the pad-printing may be done on a pre-manufactured straw (02) or on a paper straw device (20) manufactured as part of the process to create the printed paper straw.

According to an embodiment of the present invention, a printed paper straw may include a print (03) or an expression (36) of a particular meaning formed of any suitable size, shape, and design and is configured to convey a message or other meaning to the viewer of the expression. In a preferred embodiment the print (03) or expression (36) is formed from ink which has been applied to the paper straw by means of pad printing (16). The expression may be formed of ink which dyes the paper of the longitudinal tubular paper device (12), the pre-manufactured straw (02) made of paper or the paper straw device (20). While dying is shown in the arrangement, other arrangements also show other means of forming a print or an expression without dying the paper of the straw. As an example, in an alternative embodiment, the print (03) or expression (36) may be left on the surface of the longitudinal device, as such device may not always be formed of paper.

According to an embodiment of the present invention, a printed paper straw may include a print (03) or an expression (36) that may comprise of a text that is placed along the longitudinal axis of the paper straw and wherein the length of the text is substantially longer than the width of one of the plies that construct the paper straw. In another embodiment the text may be substantially longer than said distance between two helicoidal groove lines on the exterior surface of the longitudinal tubular paper device wherein the two helicoidal groove are separated by a consistent distance which is the same as the consistent width of the outer ply with of the paper straw. In another embodiment the expression may comprise of a text with a length that is at least two times longer than the distance between the two helicoidal groove lines, having as a result at least one helicoidal groove line crossing the text. In some embodiments the text may include two or more words with at least two helicoidal groove lines crossing the text. In other embodiments, the text may be longer than half of the length of the paper straw. One of ordinary skill in the art would appreciate that a text that is longer than the width of a ply can be placed with a myriad of configurations without departing from the spirit and scope of the invention.

According to an embodiment of the present invention, a printed paper straw may include a print (03) or an expression (36) that is a vertical text extending a length from a first end to a second end of the paper straw. In another embodiment, if the straw is placed with the longitudinal axis in a vertical position the text may be placed horizontally but reads vertically from top to bottom. In another embodiment, the print or expression may read in the same direction of the longitudinal paper device (12), paper straw (03) or paper straw device (20). In another embodiment, if the straw is placed with the longitudinal axis in a vertical position the text may be placed vertically but reads vertically or horizontally from top to bottom. In a preferred embodiment the print (03) may be located on the exterior surface (22), while in alternative embodiments the print (03) may be located on any surface and or portion of the paper straw. The print may be shaped in any size, design, and/or arrangement on the paper straw. In alternative embodiments, other arrangements of the print (03) in relation to the paper straw might be including but not limited to, horizontal arrangements, vertical arrangements, angled arrangements, circular arrangements, three-dimensional arrangements, and other types of special arrangements.

According to an embodiment of the present invention, a printed paper straw may include a print (03) that may be a text (04) that may include any text, such as names, abstract words, or any combination of letters. In alternative embodiments, the text (04) may include an expression (36) with specific meaning in a particular language, such as quotes, marketing phrases, slogans, or any one or more words with a specific meaning. In a particular embodiment, such expression (36) may include two or more words. On other embodiments, one print (03) or expression (36) may be placed on the longitudinal tubular paper device or paper straw while in other embodiments two or more prints or expressions may be placed in the same paper straw. In some embodiment different languages may be used for the expressions in the same longitudinal tubular paper device.

According to an embodiment of the present invention, a printed paper straw may include an expression (36) with a single text, comprised of one or more words, with an ink that has different color as the paper that comprises the paper straw. The contrast of colors, between the single text and the background of the paper straw, facilitates to catch the attention of the reader, allowing for better communication and higher retention from the reader. In alternative embodiments, the single text may use different colors that may still be different from the color of the paper straw, achieving a similar effect of catching the attention of the reader. One of ordinary skill in the art would appreciate that the text (04) or expression (36) printed on the paper straw system could include a myriad of colors, combinations, and configurations, and embodiments of the present invention are contemplated for use in any such configuration.

According to an embodiment of the present invention, a printed paper straw may include a print (03) that may be images, logos, slogans, business names, displays, appearances, designs, and/or other means of written communication. In a preferred embodiment, the logo (05) or drawing (06) may be printed with an ink that has different color as the paper that comprises the paper straw. The contrast of colors, between the single print and the background of the paper straw facilitates to catch the attention of the reader, allowing for better communication and higher retention from the reader. In alternative embodiments, a single logo (05) or single drawing (06) may use different colors that may still be different from the color of the paper straw, achieving a similar effect of catching the attention of the reader. In an alternative embodiment, a printed paper straw may include a combination of prints, such as a combination of text (04), logos (05) and drawings (06). One of ordinary skill in the art would appreciate that the prints (03) on the paper straw system could include a myriad of colors, combinations, and configurations, and embodiments of the present invention are contemplated for use in any such configuration.

According to an embodiment of the present invention, a printed paper straw may include a print (03) or an expression (36) formed by ink (07) with one color only. In alternative embodiments, the print (03) or an expression (36) may be formed by different inks that have different characteristics, such as different colors, pigments or performance to temperature. In some embodiments the ink may change the color depending on the temperature of the liquid. In some embodiments multiple colors of ink may be used.

According to an embodiment of the present invention, a printed paper straw may include a print (03) or an expression (36) formed from 100% food-grade approved materials and Ingestible/Food Grade Inks, such as those used in meat and cheese branding, drugs, sugar-coated tablets, or any product that may be directly ingested or in contact with food or drinks. In this way, consumers can be assured that the printed paper straw is completely safe to use in the consumption of liquids and/or food. In this way, the expression (36) and the rest of the printed paper straw can come into complete contact with liquids and/or other food and be safe for consumption. In a preferred embodiment, the printed paper straw may be used with liquids that may be cold or hot, thin or thick and still be safe for human consumption if and/or when contact is made between the liquid and the ink (07) of the print (03) or expression (36). Even if the print (03) covers a small portion or the entirety of the paper straw (20), the printed paper straw will still be safe for use with food. In a preferred embodiment the ink (07) may be a Food & Drug Administration (FDA) approved Ink (18) or a United States Department of Agriculture (USDA) approved Ink (18), that comes from an FDA/USDA approved Ink source (126) of a pad-printing apparatus (120). In another embodiment the ink (07) may be EU food-grade approved inks or any other country-based required certifications for inks on products that are in direct contact with food. In a preferred embodiment, the Ink (18) is formed of any suitable, size, shape, amount, and material and is configured with a viscosity which allows the ink (126) to be transferred from a plate of a pad-printing apparatus (120) to a longitudinal paper device (12), a pre-fabricated paper straw (02) or a paper straw device (20). In such arrangement, a Food & Drug Administration (“FDA”) approved ink, which is satisfactory for coming into contact with human food, to be consumed, is used. In other embodiments, where the printed paper straw may be used with decorative purposes, or where it is not expected a need for the print to be in direct contact with food or liquids, the ink (03) may be any other type of ink available in the market.

According to an embodiment of the present invention, a printed paper straw may include an FDA/USDA approved Ink (126) that include ketone, alcohol, water-based surface stamping inks, pigmented oil-based, solvent-based, dye-sublimation & UV-curable inks, coding inks, or a combination of them. In a preferred embodiment, the ink may be waterproof ink with excellent adhesion. One of ordinary skill in the art would appreciate that the ink could be manufactured with a myriad of configurations to meet current or future standards for products in direct contact with food without departing from the spirit and scope of the invention.

According to an embodiment of the present invention, a printed paper straw device may include a paper straw production apparatus (40). In a preferred embodiment, a paper straw production apparatus (40) is formed of any suitable, size, shape, and design and is configured to rapidly manufacture paper straws. The paper straw production apparatus (40) may produce longitudinal tubular paper devices (12) that may be used as paper straw devices (20) as part of the manufacturing of the printed paper straw system (10). One of ordinary skill in the art would appreciate that the paper straw production apparatus (40) could include a myriad of configurations, and embodiments of the present invention are contemplated for use in any such configuration.

According to an embodiment of the present invention, a printed paper straw device may include a paper straw production apparatus (40) that may use two or more different type of paper rolls (52) that included different papers (54). In another embodiment the outer paper may have a pre-printed drawing or text. In other embodiments the outer paper may have a continuous color or texture resulting in a final longitudinal tubular paper device (12) or paper straw that has a continuous color and texture. One of ordinary skill in the art would appreciate that there could be a myriad of configurations of the paper used for the paper straws without departing from the spirit and scope of the invention.

According to an embodiment of the present invention, a printed paper straw system (10) may include a pad-printing apparatus (120) to effectively pad-print (16), or print a two-dimensional print into a three-dimensional object, such as a longitudinal tubular paper device (12) that may be a pre-manufactured straw (02) made of paper or a paper straw device (20) specifically manufactured as part of the a printed paper straw system (10). In an alternative embodiment, a three-dimensional printer and or other printing methods that are not directly based on pad-printing are hereby contemplated for use which is capable of applying expression (36), a text (04), a logo (05) or any drawing (06) on the exterior surface (22) of longitudinal tubular paper device (12), a pre-manufactured straw (02) made of paper, or a paper straw particularly manufactured as part of the printed paper straw system (10). In an alternative process, a paper straw may be inserted into a three-dimensional printer to have a design printed and/or other apparatus for printing on a paper straw. One of ordinary skill in the art would appreciate that the print on the paper straw could be printed with a myriad of current or future solutions without departing from the spirit and scope of the invention.

According to an embodiment of the present invention, a pad-printing, or tampography, may use an indirect offset printing process that involves an image being transferred from the stereoplate, or cliché, via a silicone pad onto the substrate, in this particular case the outer surface (22) of a longitudinal tubular paper device (12) or paper straw. In a preferred embodiment the physical changes within the ink film both on the cliché and on the pad allow it to leave the etched image area in favor of adhering to the pad, and to subsequently release from the pad in favor of adhering to the substrate. The unique properties of the silicone pad enable it to pick the image up from a flat plane and transfer it to a variety of surfaces, such as flat, cylindrical, spherical, compound angles, textures, concave, or convex surfaces. Pads (124) are three-dimensional objects, that may be molded of silicone rubber but can be from alternative materials, that function as a transfer vehicle, picking up ink (126) from the printing plate, and transferring it to the longitudinal tubular paper device (12). Pads may vary in shape and size. One of ordinary skill in the art would appreciate that the pad-printing apparatus (120) and the pad-printing technology (16) could include a myriad of configurations, and embodiments of the present invention are contemplated for use in any such configuration.

According to an embodiment of the present invention, a pad-printing apparatus (120) or “pad printer” is formed of any suitable size, shape, and design and is configured to print an expression (36), a text (04), a logo (05) or any drawing (06) on the exterior surface (22) of a paper straw. In a preferred embodiment the pad printer (120) is formed of a single pad which picks up ink (126) from a plate, the ink (126) arranged in a predetermined pattern, and subsequently applies that predetermined pattern and/or expression (36) to the exterior surface (22) of a paper straw, permanently affixing the print (03) or expression (36) to the exterior surface (22) of the paper straw.

According to an embodiment of the present invention, a single pad may be utilized to print a single expression (36), while in other embodiments multiple pads and/or multiple expressions (36) printed onto a single paper straw.

According to an embodiment of the present invention, the ink (126) is situated on a plate on the pad printer apparatus (120), before the ink (126) is transferred from the plate and/or trey to a pad and subsequently to the longitudinal tubular paper device (12). In alternative embodiments the ink (126) may be applied and/or transferred to the longitudinal tubular paper device (12) in any suitable method, process, or other transfer arrangement which is suitable for creating the desired print (03) on the outside surface (22) of the device. Some of those methods may be open inkwell system, or a sealed ink cup system.

According to an embodiment of the present invention, a printed paper straw system (10) may include a graphical user interface (160) that is formed of any suitable size, shape, and design and is configured to provide a user with a means to digitally design and create a print (03) or an expression (36), and direct a pad printing apparatus (120), to apply this expression (36) to a paper straw through the use of a smart device, tablet, or computer. In this way, graphical user interface (160) is designed to be user-friendly and provide a simple design platform which is available and visible via a display. Additionally, the graphical user interface (160) may include a plurality of preloaded or pre-designed expressions (36) which may range from creative designs to company logos, such that a user could have a profile which would store user data, align this user data with designs the user can print onto paper straws. Furthermore, the graphical user interface would save a database of associated expressions for a particular user profile, allow a profile to retrieve, remove, and add new designs to their profile. Additionally, the graphical user interface (160) may allow a user to order a particular number of paper straws with the desired expression (36). Furthermore, the graphical user interface (160) may allow a user to place orders with regularity and/or automated ordering based on stock numbers associated with a user profile, which regularly update through internet connections.

According to an embodiment of the present invention, the graphical user interface (160) may include an account, a plurality of page links, a login page, a home page, an advertisement/logo/product/expression page, an order history page, a preview order page, a design interface page, a purchase page, a product database, a dataset, data, a smart device, a display, a processor, and a memory, among other pages, features, and components. One of ordinary skill in the art would appreciate that the graphical user interface could be connected with a myriad of configurations without departing from the spirit and scope of the invention.

According to an embodiment of the present invention, a printed paper straw system (10) may include an application server, a plurality of application programming interfaces, a product database, a dataset, data, a product identifier, a plurality of product characteristics, an ad identifier, a plurality of ad characteristics, a mobile application, a platform, a design, a subsequent design, an ad campaign, and a plurality of ad campaign characteristics, among other options, controls, and components.

According to an embodiment of the present invention, a printed paper straw system (10) is a process of manufacturing a longitudinal tubular paper device (12) or a paper straw (20), with approved FDA ink (126), using pad printing (16), in a way that creates a print (03) or an expression (36) which is positioned in the same direction as the longitudinal axis of the straw device (20) and along the exterior surface (22) of the straw device (20).

According to an embodiment of the present invention, a printed paper straw system (10) involves the entire process from the paper straw manufacture to the end product of paper straw with printed expression, text or logo.

According to an embodiment of the present invention, it is documented a printed paper straw system, process of manufacturing, and method of use for creating a printed longitudinal element and/or multiple advertisements and/or advertisement campaigns for a plurality of products and/or platforms is presented herein. The printed paper straw system presents multiple ways of accomplishing this task and others. Additionally, a method of use for ordering a plurality of paper straws with various expressions through a graphical user interface is also presented, among accomplishing other tasks related to uploading various logos, advertisements, designs, or other expressions to be used in advertisement methods and productions of advertisement methods and disclosed herein.

According to an embodiment of the present invention, a package of straws (08) may include straws that are uniquely identifiable by having easy-to-read text along the length of the straw, logo or drawings. Being able to buy a package of straws with unique straws inside will add a substantial improvement to the way straws are currently sold and used. In addition, having each straw being differentiated by unique text, quote, or logo can be a substantial improvement to how the straws are used. Having different texts (03), quotes, or symbols (06) on the straws inside the same package offers also a large advantage from the marketing aspect, especially for merchandising. For example, Disney® could sell packages of straws where each straw has the most famous quote from their cartoon movies, or have different straws in each of their theme parks; Marvel® could sell packages of straws with all the names of the Superheroes of their latest movie; and retailers could sell thematic packages of straws: as an example, the “Rock & Roll” package of straws could include the top 50 names of the biggest Rock & Roll players of all times, while the “Jazz” package of straws could include the top 50 names of the biggest Jazz Musicians of all times. As the straws would be different inside a package, it will be easy for a “User A” to recognize and drink from straw with “Superhero A” and for “User B” to drink from the straw with “Superhero B”. A sports team could merchandise packages of straws with the names of their players. The possibilities for merchandising a package with straws that include different texts are endless. Therefore, a preferred embodiment of the present invention may include a package of straws with different names of people, movies, groups or events dates of the year. In an alternative embodiment, the text (03) may comprise only of numbers. In an alternative embodiment, the text (03) may comprise long quotes or expressions that communicate and inspire and that may come from the same source, or author, or from different sources.

According to an embodiment of the present invention, a package of straws (08) may include straws made of different materials, such as paper, metal, hay, bamboo or glass, as a way to differentiate the straws among themselves. Packaging with this format could be used as a teaser for non-plastic straws that could be provided in corporate gifts, conventions, etc.

According to an embodiment of the present invention, a package of straws (08) may include straws made of the same material, such as paper, metal, hay, bamboo or glass, and each straw may have different prints, colors or even lengths, as a way to differentiate the straws among themselves.

According to an embodiment of the present invention, a package of straws (08) may include straws made of the same material, wherein a mark is created on each straw to differentiate them from each other, and wherein such mark is done on the exterior surface (22) of the straw by laser, pad-printing, adding stickers or any material than can be removed at the will of the user.

According to an embodiment of the present invention, a package of straws (08) may include a cover or a box to hold the straws. In some embodiment, the box might be rigid or semi-rigid, such as a board, Kraft paper, b-flute, or any hard material that may be used for packaging and selling goods. In an alternative embodiment, the box may be soft or flexible, such as a bag made of fabric, plastic, metal mesh or any other light material that may be used for packaging and selling goods. In an alternative embodiment, the cover may be opened and may consist of a rope, ribbon, tape or any other material that may hold together a diversity of longitudinal elements for packaging and selling goods. In some embodiments the cover may have openings that provide a visual relationship with the straws inside the cover, while in other embodiments the cover may be fully closed without showing the content. One of ordinary skill in the art would appreciate that the cover for a group of straw could be designed and manufactured with a myriad of configurations without departing from the spirit and scope of the invention.

According to an embodiment of the present invention, a package of straws (08) may include at least three different straws. In some embodiments, the straws may be duplicated, having as an example two different straws that repeat ten times and having a total of twenty straws. In alternative embodiments each of the straw might be different, like for example a package of fifty straws where each and every of the straw can be uniquely identified due to having a mark that is different to the others. Such mark could be a print (03), a laser-etch on the straw, a color of the straw, a color of the mark or any other system that permits to uniquely identify the straw among the rest. One of ordinary skill in the art would appreciate that marks can be done in a myriad of configurations without departing from the spirit and scope of the invention.

According to an embodiment of the present invention, a package of straws (08) may include straws made of metal, bamboo or glass wherein the package contains at least three different straws uniquely identified by a mark and wherein such mark is done on the exterior surface of the straw by a laser-etch.

According to an embodiment of the present invention, a package of straws (08) may include straws made of metal, bamboo or glass wherein the package contains at least three different straws uniquely identified by different prints, colors or even lengths, as a way to differentiate the straws among themselves.

According to an embodiment of the present invention, a package of straws (08) may include printed paper straws wherein the package contains at least three different straws uniquely identified by a mark and wherein such mark is done by a print (03) on the exterior surface of the straw created by pad-printing on the straw.

### EXEMPLARY EMBODIMENTS

According to an embodiment of the present invention, a primary function of the printed paper straw is to be used while drinking and at the same time be communicated effectively a message, either for marketing and inspirational purposes. In a preferred embodiment, the printed paper straw includes on the outside surface of the straw a text, such a word or a combination of words, that reads along the longitudinal axis of the paper straw, wherein the print is achieved by using one or more colors of ink that does not dissolve by being inside the liquids and that is not harmful. As an illustrative example, said ink may be FDA approved ink for being in contact for food. In a preferred embodiment, the print is done through a pad-printing process on a pre-manufactured plain raw paper straw, that may be manufactured in the same location where the pad-printing apparatus is placed or in a completely different location. In an alternative embodiment the printed paper straw may include single logos, drawings or symbols printed on the outside surface of the paper straw. In a preferred embodiment, the outer paper ply used to manufacture the paper straw have the same color so said print stands out and is easier to read. In an alternative embodiment the outer paper ply used to manufacture the paper straw may have different colors or even textures. One of ordinary skill in the art would appreciate that the print on the printed paper straw system could be arranged in a myriad of configurations, and embodiments of the present invention are contemplated for use in any such configuration.

According to an embodiment of the present invention, a primary function of the package of straws that include uniquely identifiable straws is to be used in private or public events where finding the drink among a crowd is required. In a preferred embodiment, the package of straws includes at least three different type of straws, wherein each straw included in the outside surface of the straw a text, such a word or a combination of words, that reads along the longitudinal axis of the paper straw. In an alternative embodiment all the straws inside the package are different from each other and include a differentiative feature, such as a distinctive logo, drawing or text. One of ordinary skill in the art would appreciate that the package of uniquely distinctive straws could be arranged in a myriad of configurations, and embodiments of the present invention are contemplated for use in any such configuration.

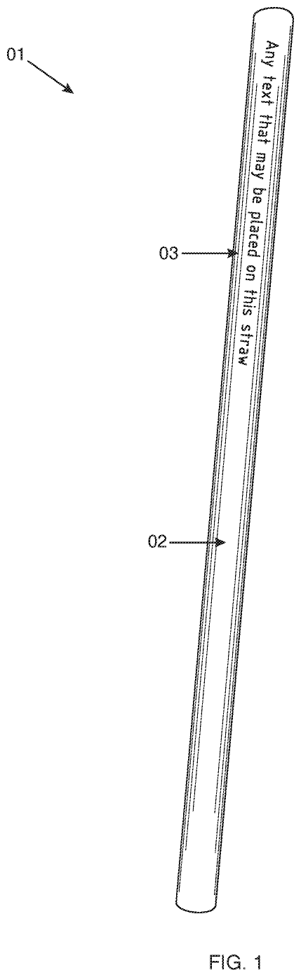

Turning now to FIG. 1, an exemplary embodiment of a printed straw (01), in accordance with an embodiment of the present invention. In this exemplary embodiment, the printed straw (01) is a result of a print (03) being pad-printed (16) in a pre-manufactured straw (02), with a text (03) that is parallel to the main axis of the straw.

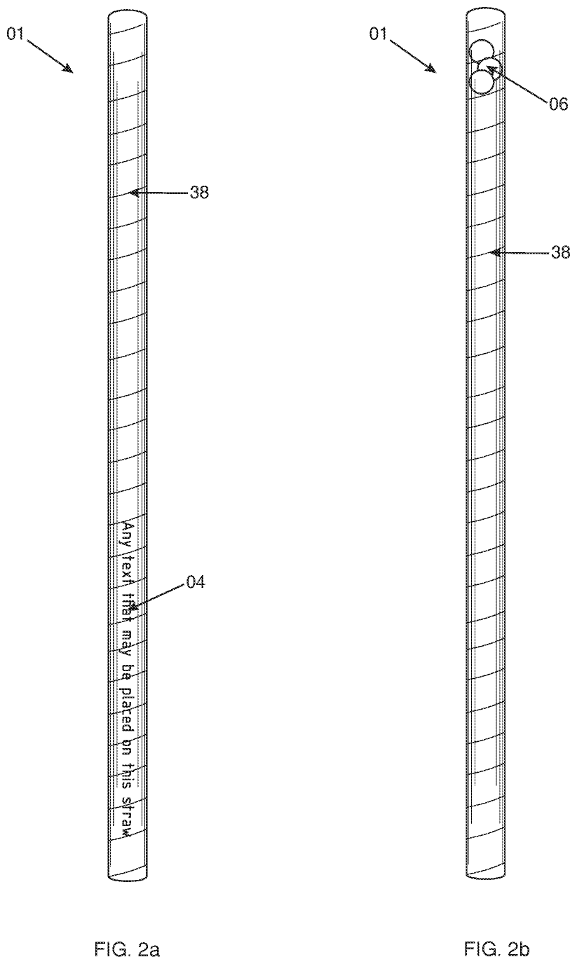

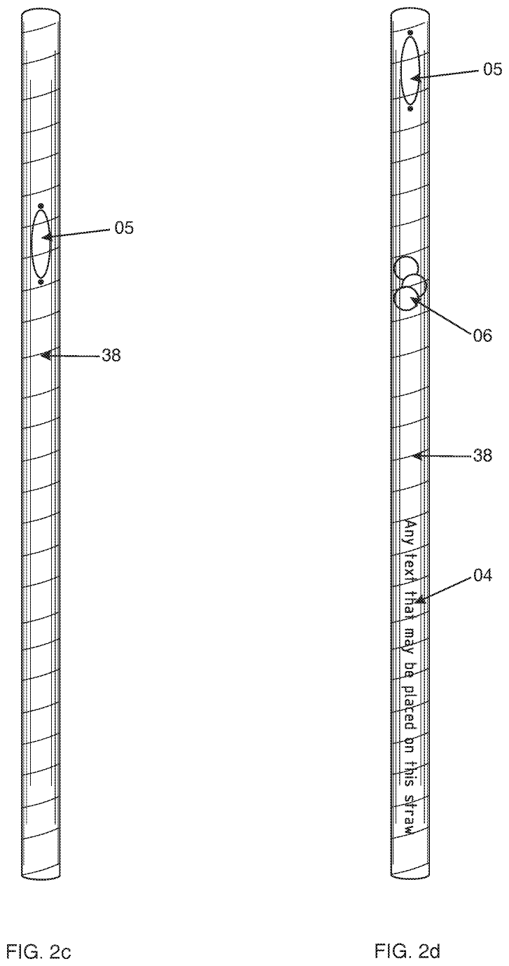

Turning now to FIG. 2a-2d, an exemplary embodiment of a printed paper straw (01) wherein the prints (03) are text (04), a single logo (05), drawings (06) or a combination of them, in accordance with an embodiment of the present invention. In this exemplary embodiment, the printed paper straw comprises a paper straw (02), helicoidal groove lines (38), and a print on the exterior surface (22) of the straw.

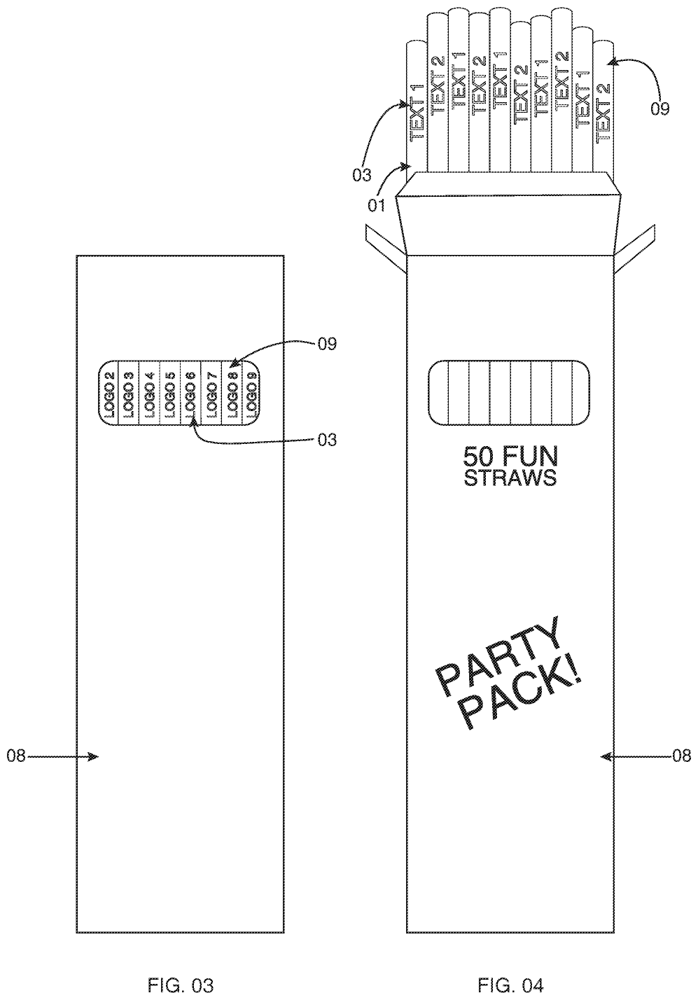

Turning now to FIG. 3, an exemplary embodiment of a package (08) that contains straws with different prints (09) to be able to differentiate the straws among themselves, in accordance with an embodiment of the present invention. In this exemplary embodiment, each print (03) or expression is different for each straw on the package.

Turning now to FIG. 4, an exemplary embodiment of a package (08) of straws, with the straws partially out of the package, wherein there are at least two different prints on the straws, to be able to differentiate the straws among themselves, in accordance with an embodiment of the present invention.

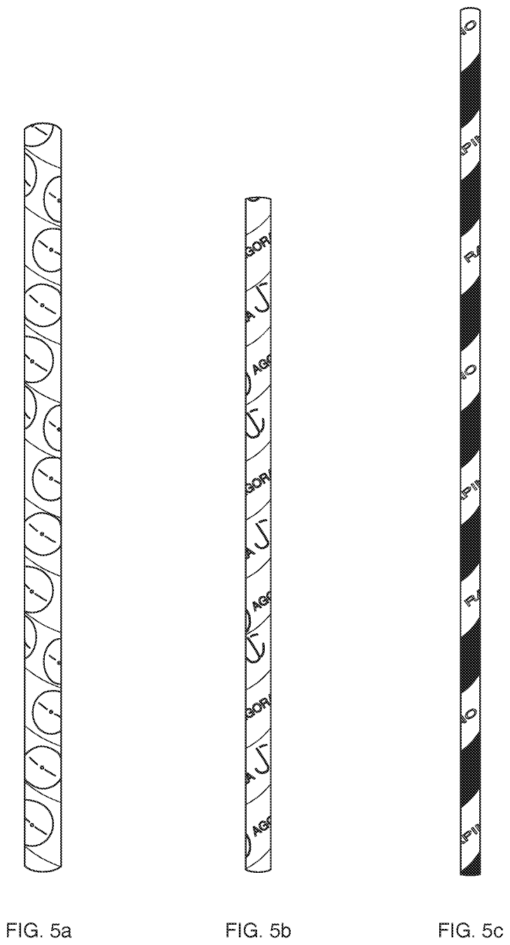

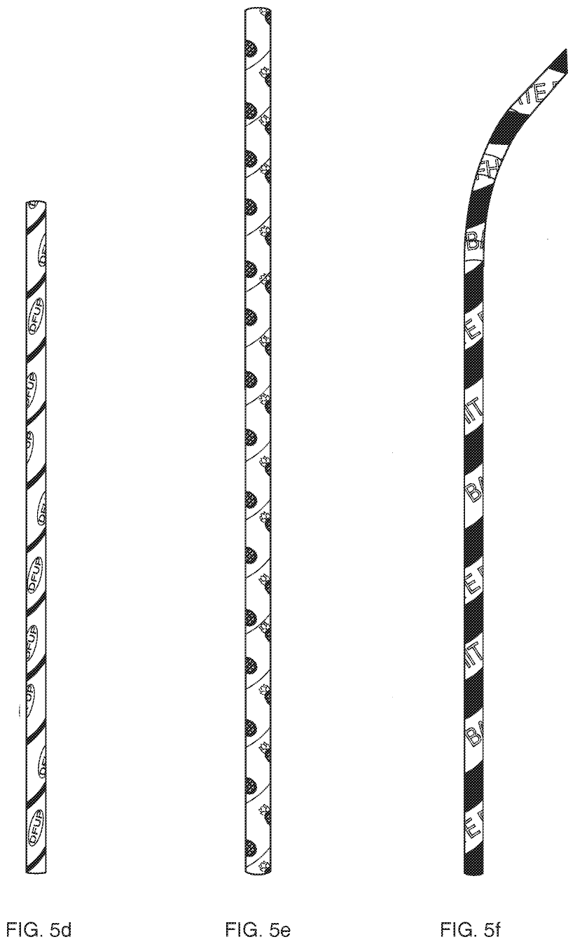

Turning now to FIG. 5a-5f, an exemplary embodiment of current prior art related to paper straws that have prints on their surface. These exemplary prior art embodiments explain the challenges that the current solutions of paper straws face to provide a clear single and effective message to the user. In the prior art disclosures, the logos cannot be placed on the straw in a single manner, as they are repeated across the straw. In these embodiments the print is done prior to manufacturing the straw and they are printed on the paper roll associated with the outer ply. The edges of the width of the outer ply create the helicoidal groove lines after wrapping around a cylinder. As the prints have to be pre-printed on a continuous paper that is on a paper rolls, the print shows multiple times on the final paper straw. For example, in FIG. 5c it is possible to observe 7 full rounds of the same outer ply that has a zebra-skin pre-print on it. As illustrated in the FIGS. 5a-5c the prints on the prior art cannot be perfectly alighted in the longitudinal direction of the straw, because the helicoidal construction of the paper straw. Another challenge that the current prior art faces is that in the case that two different patterns want to be used, they have to be done following the helicoidal groove. Additionally, in the case a text wants to be shown on the straw, it has to follow the helicoidal direction, making it very complicated for a user to read the message, and making it almost impossible for a phrase or a text to be effectively disclosed on the outer surface of a paper straw. Additionally, the text might be cut in half or parts of the text might be repeated on the straw.

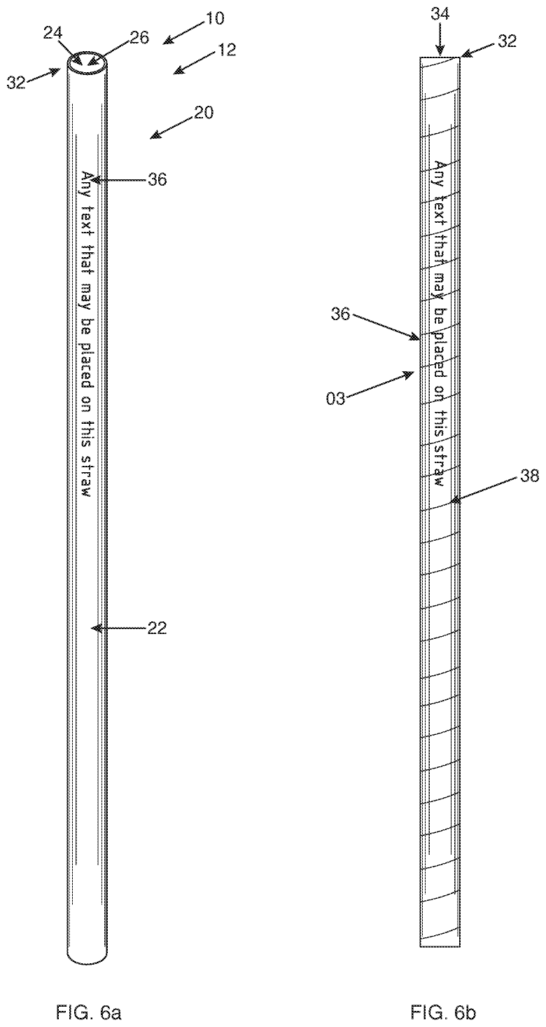

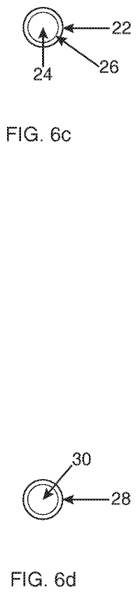

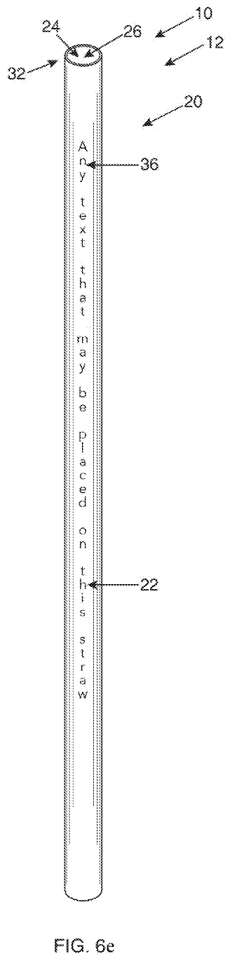

Turning now to FIG. 6a-6e, an exemplary embodiments of a printed straw system, in accordance with an embodiment of the present invention. In these exemplary embodiments, a printed straw system (10) may be formed by a longitudinal tubular paper device (12) that functions as a paper straw (20), having an exterior surface (22) which wraps cylindrically around a circumference that has an interior surface (26) on the opposite side of the exterior surface (22). Together these surfaces form a hollow interior (22) which extends the length of the straw from a first opening (30) at a first end (28) to a second opening (34) at a second end (32). As seen in FIG. 6b, the longitudinal tubular paper device (12) may also comprise helicoidal groove lines (38) that are exposed on the exterior surface (22). As seen in FIG. 6e each letter of the text is placed in the perpendicular direction of the longitudinal axis of the straw.

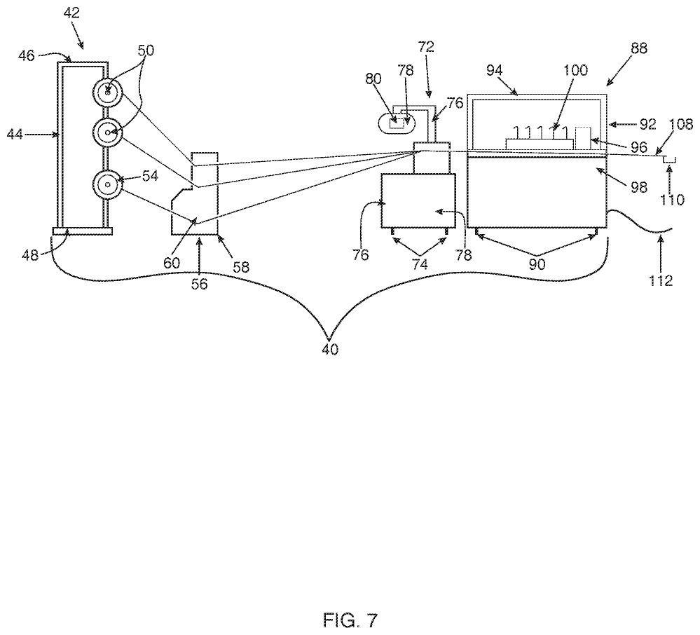

Turning now to FIG. 7, an exemplary embodiment of the paper straw production, as part of the printed paper straw system, in accordance with an embodiment of the present invention. In this exemplary embodiment, as part of the manufacturing of the printed paper straw system (10), it is illustrated a paper straw production apparatus (40) that may produce longitudinal tubular paper devices (12) or paper straw devices (20). As an example, a paper straw production apparatus (40) is formed of a plurality of stations which make up a single production assembly; these various stations include, but are not limited to a feeder stand (42), a soaker (56), a winding machine (72), a chopper (88), a plurality of conveyors (108), and a bin (110), among other stations, arrangements, and production processes. In the example the paper straw production apparatus is designed to create paper straws by affixing paper strands and/or portions of paper together in a winding pattern which stabilizes the paper straws. The paper straw production apparatus (40) may include a feeder stand (42) having a plurality of posts (44), a plurality of lintels (46), a plurality of feet (48), a plurality of pegs (50), wherein the pegs are configured to support free moving wheels of paper, a plurality of peg clips (51), wherein the peg clips are configured to stabilize the wheels of paper, paper rolls (52), paper (54), among other features. Additional elements such as a power supply (112), among other options, controls, features, and components may be provided.

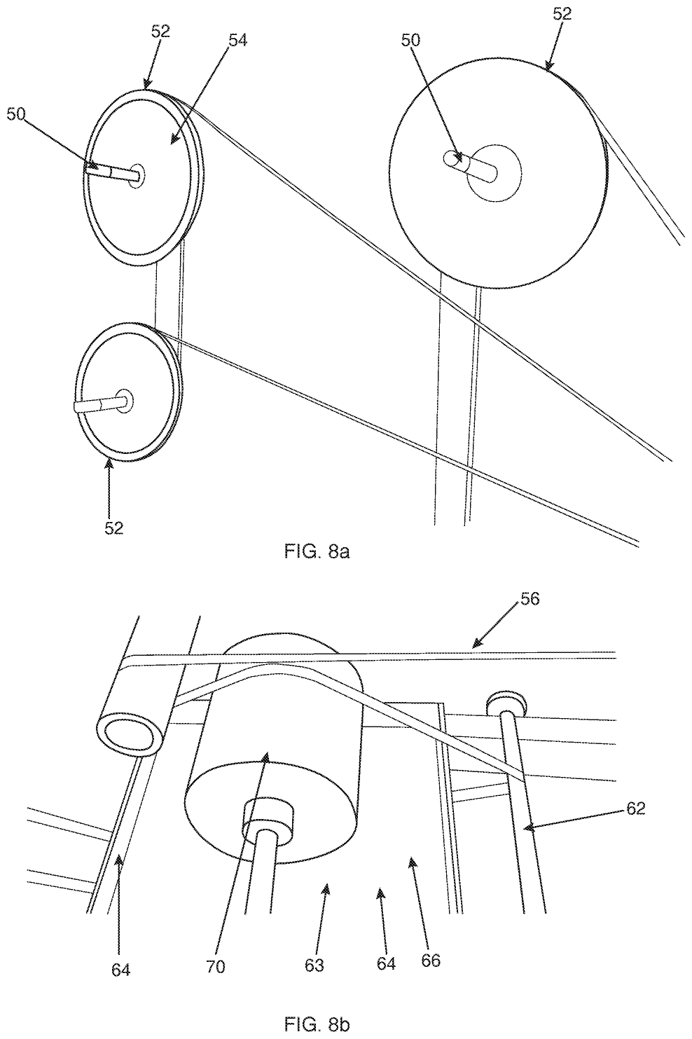

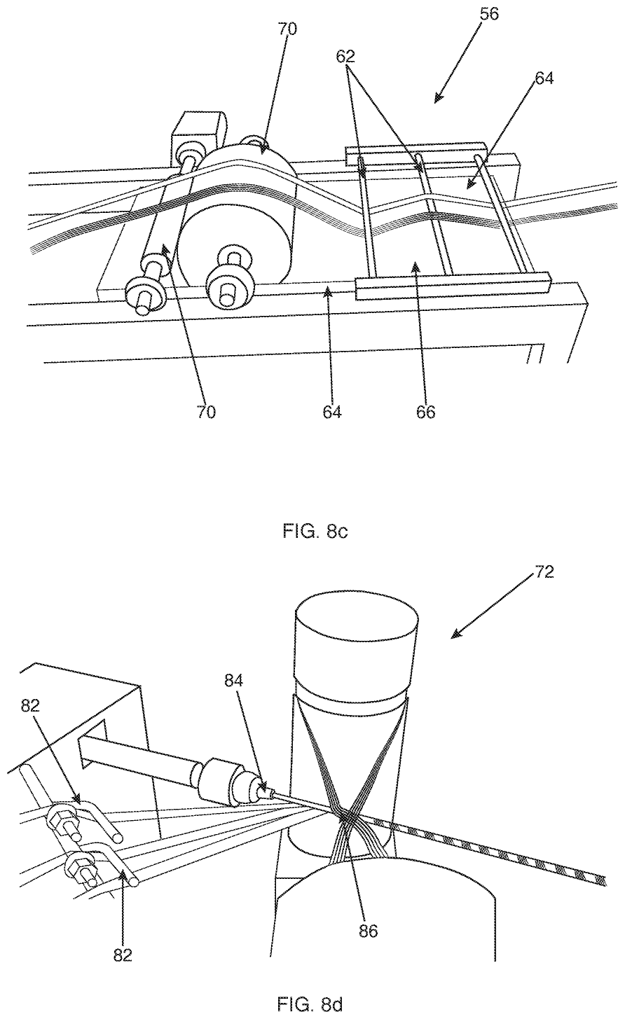

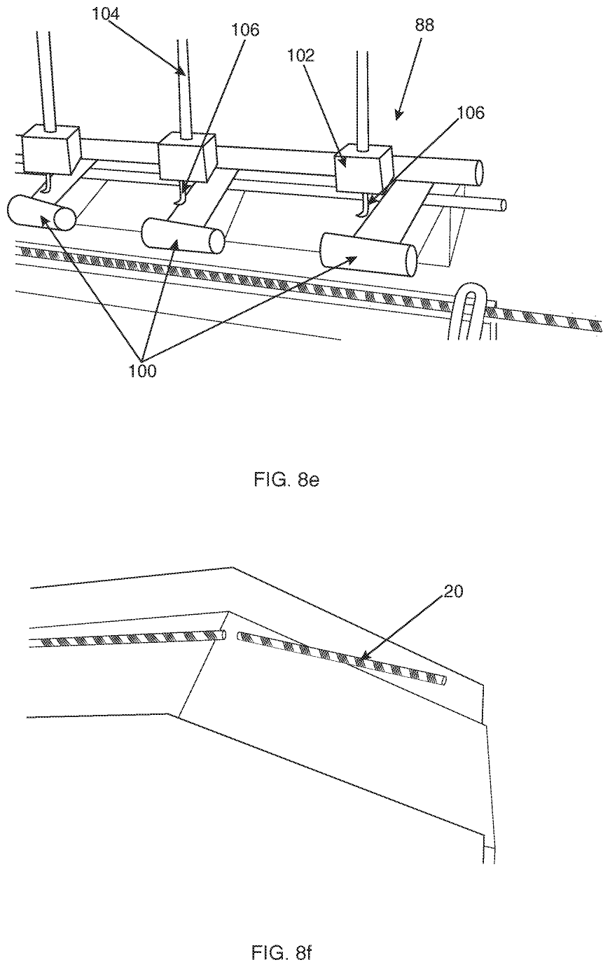

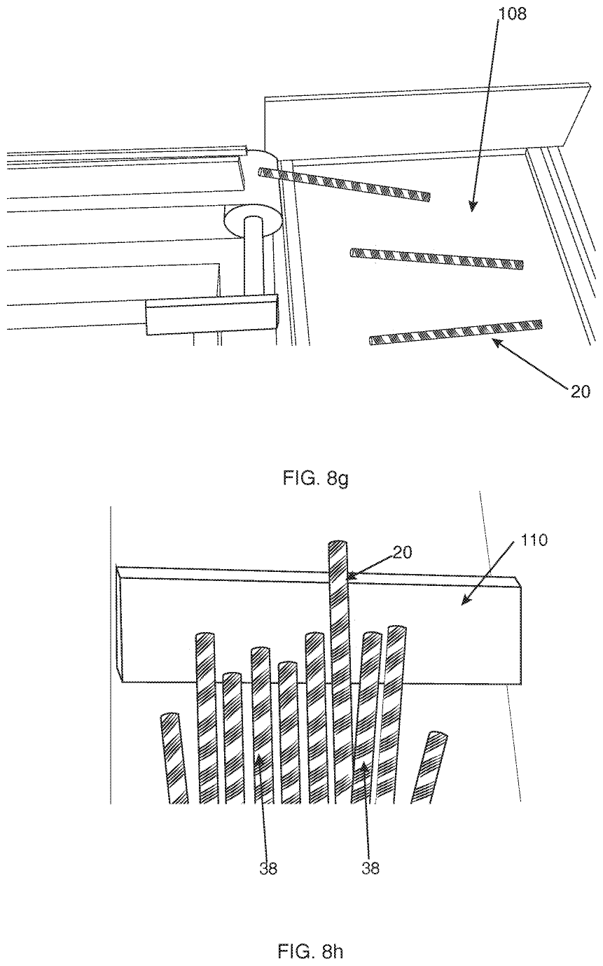

Turning now to FIG. 8a-8h, an exemplary embodiment of the detailed components of the paper straw production apparatus (40), in accordance with an embodiment of the present invention. A feeder stand (42) three paper rolls (52) loaded onto the pegs of a paper feeder apparatus. Each paper roll includes a ply of paper (54) of a certain width, that may be undyed or pre-printed. In occasions the outer ply may be pre-printed while the two inner plies are undyed. In occasions all plies of paper may be the same characteristics while in other cases each ply of paper may have different characteristics, such as different width, different color or different water resistance performance.

As part of the paper straw production process, at least one of these paper strands are then fed through a bath of adhesive (63). This component may include a soaker (56) having a plurality of feet (58), a plurality of lintels (59), a plurality of controls (60), at least one straightener or aligner (62), at least one bath (64), an adhesive (66) and/or other attachment means (66), a soaking liquid (68), and feeder rolls (70), among other components;

Once one or more paper strands have the opportunity to pick up adhesive, the strands are guided into a winding machine, then helicoidally wraps the paper strands in a pattern around any one of varying circumferences. This phase is created by a winding machine (72) having a plurality of feet (74), a plurality of posts (76), a plurality of lintels (78), a plurality of controls (80), a plurality of guides (82), at least one gauge (84), and at least one winding point (86), among other components.

Once the paper is wrapped, the longitudinally formed length of paper with a hollow interior is wound to a cutting machine, or a plurality of cutting machines. These cutting knives cut the singular straw into predetermined lengths. This phase is created by a chopper (88) having a plurality of feet (90), a plurality of posts (92), a plurality of lintels (94), at least one safety feature (96), a plurality of controls (98), rolling knives (100), a compressor (102), springs (104), a plurality of sensors (106), among other components; a conveyor belt system (108).

As the straw is cut, the cut straws fall onto a conveyor belt system which carries the cut paper straws to a bin (110).

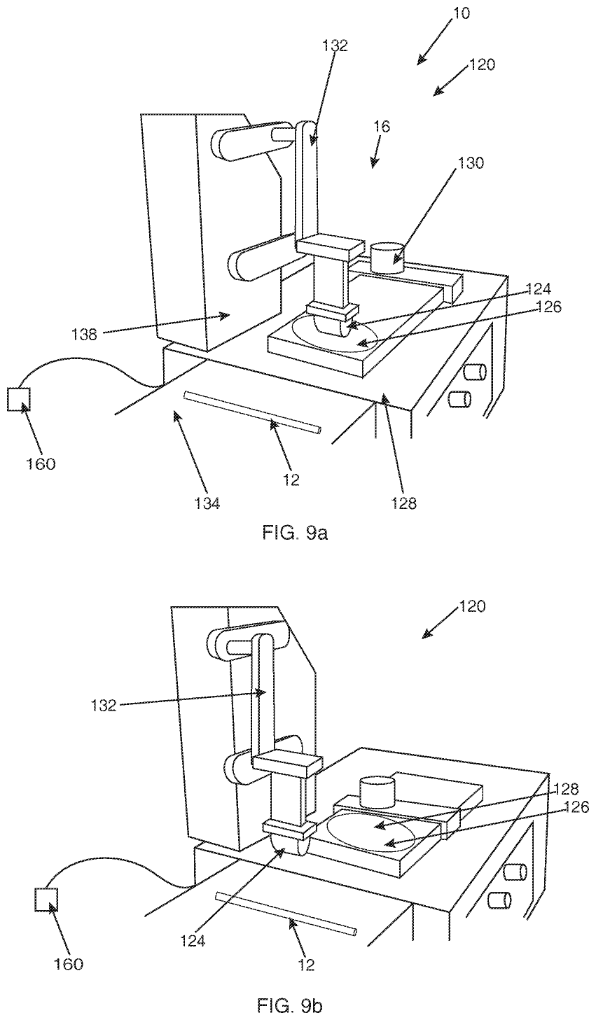

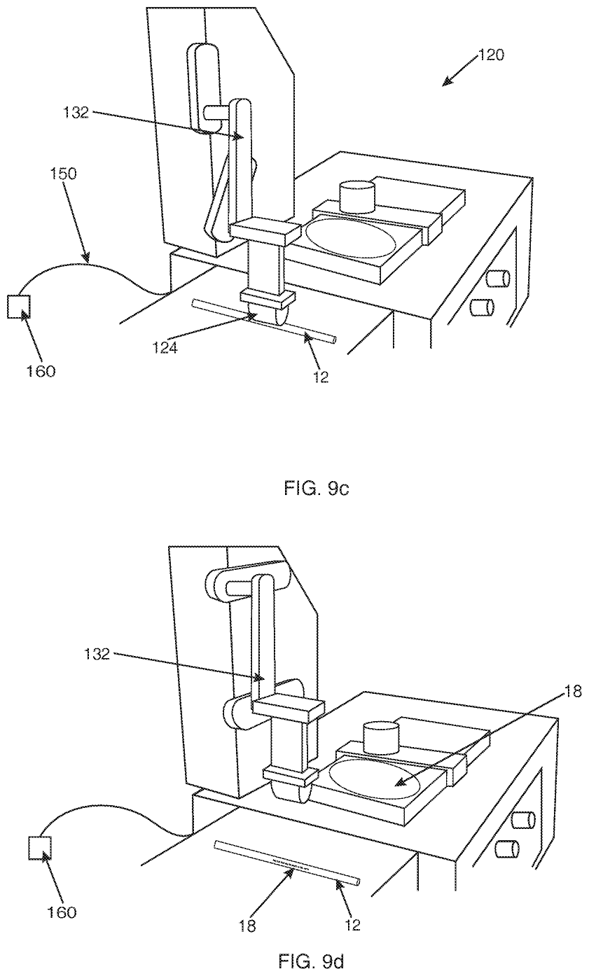

Turning now to FIG. 9a-9d, an exemplary embodiment of the processing and method for the pad-printing, as part of the printed paper straw system, in accordance with an embodiment of the present invention. In this exemplary embodiment, an exemplary method for manufacturing the printed paper straw from paper straws already manufactured is documented in accordance with an embodiment of the present invention. In this exemplary embodiment, a longitudinal tubular paper device (12) is used to pad-print a text (04) or an expression (36) on the outer surface of the straw.

In this process, the straws are lined to a pad-printing apparatus (120) or pad printing machine (120) and laid on a conveyor belt (140). The pad printing apparatus can stamp expressions onto one straw or multiple straws at once as the conveyor system aligns and pauses as is necessary for stamping. The pad printing apparatus (120) utilizes a plurality of pads (124) capable of holding ink (126), the pads attached to mechanical arms (132) which can move from ink plate (128) to paper straw (12) and back with repetition. The plates (128) of the pad printers have an expression (36) engraved in the plate which is the expression desired to be printed on the paper straws. This engraving or design allows the plate to hold ink in the template desired. Once the template is holding ink, a pad (124) presses into the template gathering the desired amount of ink in the desired arrangement, the pad is then moved to the paper straw, where the pad is pressed against the paper straw, transferring the ink, in the desired arrangement, to the paper straw. While the pad is pressing the arranged ink against the straw, a slider or ink refresher (130) is replenishing the plate/template with ink. This process repeats as many times as necessary until the desired number of straws with the desired expressions are created. The conveyor (140) system then carries the printed straw to another bin or sorting location. In some embodiments, the conveyor belt (140) of pad printing machine (120) may be connected to the convey belt (108) of the paper straw production apparatus (40), while in others both systems might be completely separated.

In this process, an FDA approved ink is applied to a paper straw in any arrangement or desire. The straw can be used in a variety of ways which is new in the state of the art. In this way, the result of the expression which can be attached to the straw can be arranged in any desired manner. In particular, a length arranged vertically along the length of the straw can be attained or said in a different manner, where the text reads in the same direction of the longitudinal axis of the straw. Furthermore, an FDA approved ink (18) can be used such that the ink can come into contact with a liquid and an end user can see and/or reveal the expression and/or advertisement for marketing purposes such that the paper straw can be used in the consumption of liquids and simultaneously in marketing and/or advertising.

As an alternative option, in another process, the above tasks are accomplished through a graphical user interface (160). In this way, a user would login to a user's profile or online platform to place an order for paper straws with a custom printed expression. In the event of using a profile, a user would log in to their previously created profile and have access to previously uploaded and/or designed expressions for printing on paper straws. Additionally, a user would be able to upload new designs and/or new expression as well as create new designs through a design page which allows a user to create customized expressions directly on a graphical user interface. Once a new design is uploaded/created and/or a previous design is selected, a user can direct a particular number of these designs to be printed on any one of or a plurality of various paper straw patterns ranging from plane to multi-colored as would be created in the paper straw making process described herein. In this way, a user can order a custom expression on a custom paper straw design through a graphical user interface. Additionally, a user can set subscriptions such that orders can be placed with single click ordering when a stock runs low. Additionally, the processes above include marketing and/or advertising campaigns such that advertising and/or promotional messages can be used as expressions. In this way, and even through the graphical user interface, a user can place an order for a certain number of paper straws promoting the users business and/or products and/or services. In this way, a logo might be printed which along prominently sits upon the paper straw in a vertical orientation which directly and powerfully matches the straw such that a consumer directly notices the logo and/or message. In this way, a user may also reveal the message/expression as a liquid is consumed and moves down the length of the paper straw due to gravity.

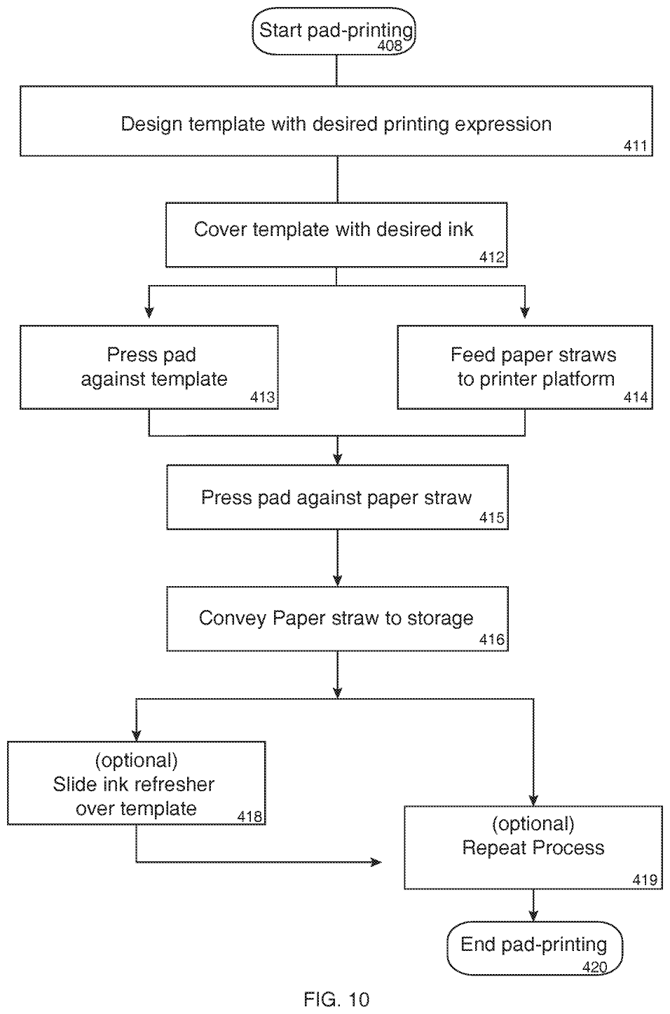

Turning now to FIG. 10, an exemplary method for pad-printing the printed paper straw container is shown. The process starts at step 408 with the beginning of the pad-printing. In step 411 the design, print or expression that may be placed on the straw is decided. In step 412 the template with the intended design is manufactured so it is ready to have the ink on the template as needed for the next steps. After step 412, the steps 413 and 414 are required and pay occur at the same time or one after the other. 413 represents the pad pressing the template to absorb or attach the ink to the pad with the pattern of the template. 414 places the straw on the right location so the pad can properly mark the print. The straw may be pre-manufactured and sourced from a third party or may be manufactured at the same location as part of a complete printed paper straw device manufacturing. In some embodiments the step 414 may be occur as a first step without departing from the spirit and scope of the invention. An arm, either from a human or mechanic moves the pad from the template until the location of the straw and press the pad against the straw (415). After step 415 the arm moves out and the straw is placed to storage that may be done by hand, robotic arms or by a convey belt. In case more straws are needed, the process starts again (419). The ink is may be refreshed at the template with a slider (418) which could also happen at the same time that the previous straw is sent for storage or once the new round of pad-printing is produced. Once there is no more need for printed paper straws, the process ends at 420.

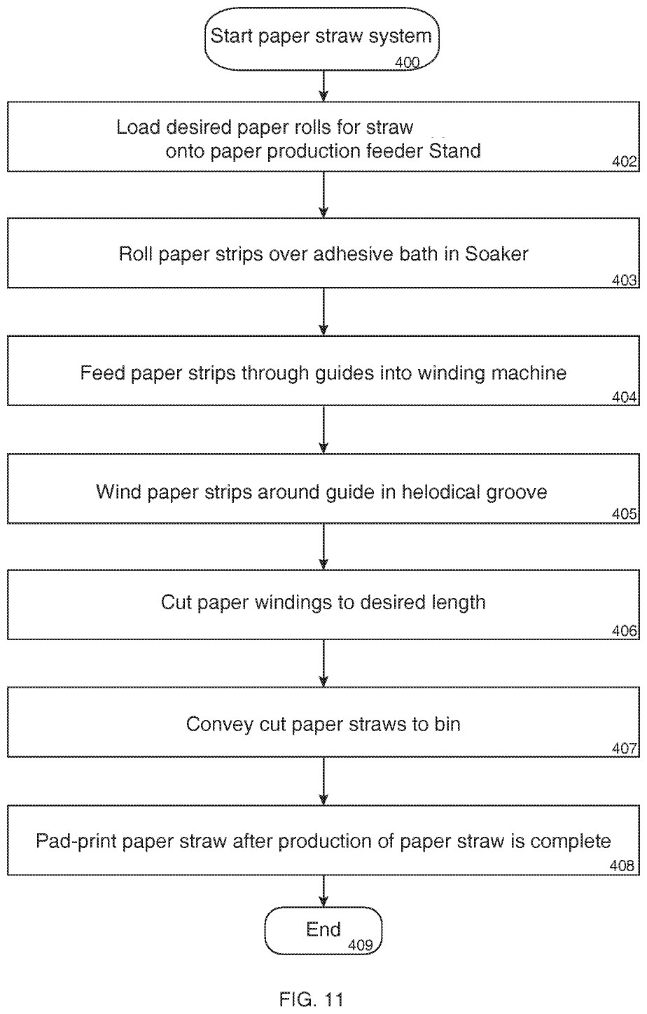

Turning now to FIG. 11, an exemplary method for manufacturing the printed paper straw, in accordance with an embodiment of the present invention. The process starts with the paper straw system manufacturing 400. The step 402 loads the desired paper rolls for straw production onto the paper feeder stand. The rolls may have the same or different type of paper. Step 403 illustrates at least one roll paper being pulled and stripped over an adhesive bath in a soaker. Step 404 represents the feed paper that strips through guides into a winding machine that combines the plies of paper into a single straw, which is executed by step 405, where the wind paper strips around a guide creating a helicoidal groove on the straw. Next step is 406 which cuts the long paper windings to the desired length of the straw. Next step is 407 where a cut paper is transferred to a storage bin. A pad-printing process follows (408), wherein 408 is the beginning of the pad-printing. In step 411 the design, print or expression that may be placed on the straw is decided. In step 412 the template with the intended design is manufactured so it is ready to have the ink on the template as needed for the next steps. After step 412, the steps 413 and 414 are required and pay occur at the same time or one after the other. 413 represents the pad pressing the template to absorb or attach the ink to the pad with the pattern of the template. 414 places the straw on the right location so the pad can properly mark the print. The straw may be pre-manufactured and sourced from a third party or may be manufactured at the same location as part of a complete printed paper straw device manufacturing. In some embodiments the step 414 may be occur as a first step without departing from the spirit and scope of the invention. An arm, either from a human or mechanic moves the pad from the template until the location of the straw and press the pad against the straw (415). After step 415 the arm moves out and the straw is placed to storage that may be done by hand, robotic arms or by a convey belt. In case more straws are needed, the process starts again (419). The ink is may be refreshed at the template with a slider (418) which could also happen at the same time that the previous straw is sent for storage or once the new round of pad-printing is produced. Once there is no more need for printed paper straws, the process ends at 420. Some embodiments might further include an automated packaging apparatus that combines in a container or box a group of the printed paper straws.

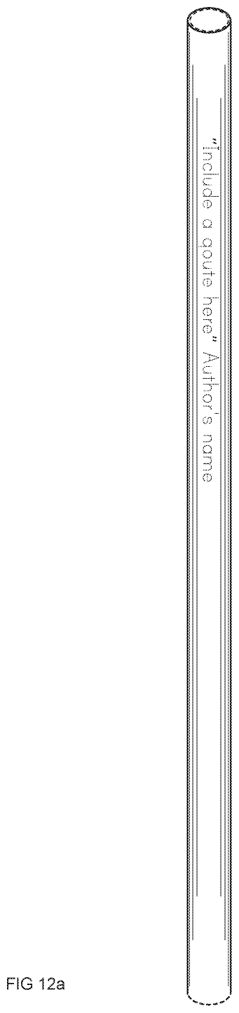

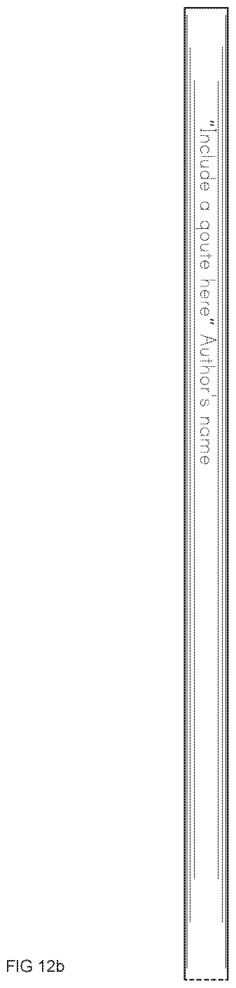

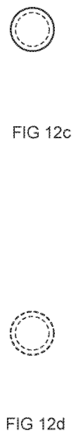

Turning now to FIG. 12a-12d, an exemplary straw is illustrated, in perspective, elevational and plan views, wherein the marking or expression on the straw consists of a quote. In some embodiments such quote may include quotation marks while in other embodiments the quotation marks may be eliminated but might still be a quote from a person, group of people or cultural knowledge from the past or the present times.

Each element in flowchart illustrations may depict a step, or group of steps, of a preferred embodiment of the methods described herein. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order unless required by a particular application, explicitly stated, or otherwise clear from the context.

While multiple embodiments are disclosed, still other embodiments of the present invention will become apparent to those skilled in the art from this detailed description. There may be aspects of this invention that may be practiced without the implementation of some features as they are described. It should be understood that some details have not been described in detail in order to not unnecessarily obscure focus of the invention. The invention is capable of myriad modifications in various obvious aspects, all without departing from the spirit and scope of the present invention. Accordingly, the drawings and descriptions are to be regarded as illustrative in nature and not restrictive.

1. A printed paper straw, comprising:
a paper tubular device comprising an outer ply with a consistent width, at least one additional inner ply, an exterior surface formed by said outer ply, two helicoidal groove lines on said exterior surface that are separated by a consistent distance, a longitudinal axis, a first end-point at the end of said longitudinal axis, a second end-point at the opposite end of said longitudinal axis, and a hollow interior from said first end-point to said second-end point; and
a text that has a length and that comprises one or more words;
wherein said hollow interior is configured to move liquid from said first end-point to said second end-point;
wherein said text is on said exterior surface of said paper tubular device;
wherein said text reads in the same direction as said longitudinal axis of said paper tubular device;
wherein the length of said text is longer than said distance between said two helicoidal groove lines;
wherein said text is pad-printed after said paper tubular device is manufactured; and
wherein said text is pad-printed with one or more colors of ink that is ingestible or food grade.

2. The printed paper straw of claim 1,
wherein said paper tubular device is pre-manufactured with at least three plies of paper; and
wherein said outer ply is undyed or have the same color across its consistent width.

3. The printed paper straw of claim 1, wherein the length of said text is at least two times longer than said distance between said two helicoidal groove lines, having as a result at least one helicoidal groove line crossing said text.

4. The printed paper straw of claim 1, wherein said ingestible or food grade ink is approved by the Food & Drug Administration (FDA) or by the United States Department of Agriculture (USDA) to be in direct contact with food or liquids.

5. The printed paper straw of claim 1, wherein each letter of said text is placed in the perpendicular direction of the longitudinal axis of said paper tubular device.

6. The printed paper straw of claim 1, wherein said paper tubular device is flexible, foldable, bendable or articulated with a hinge.

7. The printed paper straw of claim 1, further comprising a drawing or a logo,
wherein said drawing or said logo is on said exterior surface of said paper tubular device;
wherein said drawing or said logo is pad-printed; and
wherein said drawing or said logo is pad-printed with one or more colors of ink that is ingestible or food grade.

8. A printed paper straw, comprising:
a paper tubular device comprising an outer ply with a consistent width, at least one additional inner ply, an exterior surface formed by said outer ply, two helicoidal groove lines on said exterior surface that are separated by a consistent distance, a longitudinal axis, a first end-point at the end of said longitudinal axis, a second end-point at the opposite end of said longitudinal axis, and a hollow interior from said first end-point to said second-end point; and
one single drawing or logo that has a length;
wherein said hollow interior is configured to move liquid from said first end-point to said second end-point;
wherein said single drawing or logo is on said exterior surface of said paper tubular device;
wherein said one single drawing or logo is shown only once and is not repeated anywhere else on the printed paper straw;
wherein said single drawing or logo is pad-printed after said paper tubular device is manufactured; and
wherein said single drawing or logo is pad-printed with one or more colors of ink that is ingestible or food grade.

9. The printed paper straw of claim 8, further comprising a text or an expression,
wherein said text or said expression comprises one or more words and that has a length;
wherein said text or said expression is on said exterior surface of said paper tubular device and reads in the same direction as said longitudinal axis of said paper tubular device;
wherein the length of said text or said expression is longer than said distance between said two helicoidal groove lines;
wherein said text or said expression is pad-printed on said paper tubular device; and
wherein said text or said expression is pad-printed with one or more colors of ink that is ingestible or food grade.

10. The printed paper straw of claim 8, wherein said printed paper straw is manufactured as an integrated process comprising of:
a paper straw production apparatus comprising of two or more paper rolls, a soaker with adhesive, a plurality of controls, at least one aligner, a winding machine, a plurality of guides, at last one chopper, and a conveyor belt system; and
a pad-printing apparatus comprising of a plate prepared to hold ingestible or food grade ink, a mechanical arm, an ink refresher, and a conveyor belt system.

11. The printed paper straw of claim 10, wherein said printed paper straw is manufactured as an integrated process that further comprises an automated packaging apparatus that combines a group of said printed paper straw in a container.

12. The printed paper straw of claim 10, wherein said printed paper straw is manufactured as an integrated process that further comprises a graphical user interface.

13. The printed paper straw of claim 8, wherein said paper tubular device is flexible, foldable, bendable or articulated with a hinge.

14. A package of printed paper straws comprising:
two or more uniquely differentiated printed paper straws, each constructed of a paper tubular device comprising an outer ply with a consistent width, at least one additional inner ply, an exterior surface formed by said outer ply, a print on the exterior surface, two helicoidal groove lines on said exterior surface that are separated by a consistent distance, and a longitudinal axis; and
a cover or a box that holds said two or more uniquely differentiated printed paper straws;
wherein said print on each of said two or more uniquely differentiated printed paper straws is what creates said unique differentiation among said two or more printed paper straws.

15. A package of printed paper straws of claim 14, wherein each said two or more uniquely differentiated printed paper straws is repeated inside said package at least twice.

16. A package of printed paper straws of claim 14, wherein each and every printed paper straw contained inside said package is uniquely differentiated from each other.

17. A package of printed paper straws of claim 14,
wherein said print may be any print selected from a group of prints consisting of a text, an expression, a drawing, a logo, a symbol, an image, a slogan, a business name, and a removable sticker; and
wherein said print is pad-printed with one or more colors of ink that is ingestible or food grade.

18. A package of printed paper straws of claim 17, wherein said print on the exterior surface of said uniquely differentiated printed paper straws is a single print.

19. A package of printed paper straws of claim 17,
wherein said print is a text that that reads in the same direction as said longitudinal axis of said paper straw; and
wherein the length of said text is longer than said width of one of said plies of paper that construct each of said three or more uniquely differentiated printed paper straws.

20. The printed paper straw of claim 19, wherein the length of said text is at least two times longer than said distance between said two helicoidal groove lines, having as a result at least one helicoidal groove line crossing said text.
